(19) United States
(12) Patent Application Publication
(10) Pub. No.: US 2022/0219705 A1
(43) Pub. Date: Jul. 14, 2022

(54) Method for Predicting and Reducing Kinetosis-Induced Disturbances

(71) Applicant: Daimler AG, Stuttgart (DE)

(72) Inventor: Dominique BOHRMANN, Trier (DE)

(21) Appl. No.: 17/610,989

(22) PCT Filed: May 11, 2020
(86) PCT No.: PCT/EP2020/063006

§ 371 Date: Nov. 12, 2021

(30) Foreign Application Priority Data
May 15, 2019 (DE) 10 2019 003 429.5

(51) Int. Cl. B60W 40/08; B60W 60/00; B60W 10/30

(52) U.S. Cl. CPC B60W 40/08; B60W 60/0013; B60W 10/30; B60W 2540/229; B60W 2420/42; B60W 2540/225; B60W 2540/221

(57) ABSTRACT

A method for predicting and reducing kinetosis-induced disturbances of an occupant in driving of a vehicle includes detecting the occupant by a vehicle camera, determining a characteristic figure that indicates a probability of onset of kinetosis-induced disturbances as a function of stimuli acting on the occupant, an individual susceptibility of the occupant with respect to kinetosis, and a type of activity carried on while driving, and as a function of the determined characteristic figure determined, recommending at least one individual measure of a package of measures for preventing kinetosis-induced disturbances to the occupant or initiating automatically the at least one individual measure.

### BACKGROUND AND SUMMARY OF THE INVENTION

The invention relates to a method for predicting and reducing or avoiding kinetosis-induced disturbances of an occupant travelling in a vehicle, wherein the occupant is monitored at least by means of a vehicle camera.

A method for operating a vehicle is known from DE 10 2017 206 012 B3. The method provides that at least one first sensor unit detects movements of at least one region of the body of at least one vehicle occupant and/or of at least one object with which the vehicle occupant interacts. By means of a control unit, at least one driving system is controlled as a function of the movements detected. The movement detected is at least one waveform as a function of time and the waveform is detected from the amplitude and/or frequency of the at least one vibration.

The aim of the invention is to provide an improved method, relative to the prior art, for predicting and reducing kinetosis-induced disturbances of an occupant travelling in a vehicle.

The invention relates to a method for predicting and reducing or avoiding kinetosis-induced disturbances of an occupant travelling in a vehicle, wherein the occupant is monitored at least by means of a vehicle camera. According to the invention, as a function of stimuli acting on the occupant, a characteristic figure is determined for an individual susceptibility of the occupant in relation to kinetosis and for a type of activity engaged in during the journey, which indicates or predicts the probability of onset of kinetosis-induced disturbances. Depending on the characteristic figure determined, at least one individual measure from a package of measures for preventing kinetosis-induced disturbances is recommended to the occupant or initiated automatically.

By using the method, the occupant is offered the possibility of being able to utilize travel time efficiently for carrying out activities, without the occupant being exposed to the risk of onset of kinetosis-induced disturbances. For people who are particularly susceptible, the program can also be used for preventing or alleviating kinetosis, without secondary activities being carried out.

For example, the use of the method in the vehicle as an activatable anti-kinetosis program, in particular in the autonomous driving mode of the vehicle, is available to the occupant.

Thus, the method comprises on the one hand the prediction of potential kinetosis-induced disturbances of the occupant and on the other hand individual measures, i.e., countermeasures, for preventing the onset of kinetosis-induced disturbances.

In one embodiment of the method, a type of activity is assigned to an activity category, i.e., clustered, as a function of a degree of distraction and attention and/or demands on the occupant's attention, a required visual dynamics of the occupant, a required constant attention and/or a slight turning away of the occupant's gaze and/or the occupant's sitting position in the vehicle. Thus, the activities are summarized in regard to their form, so that the determination of a countermeasure that reduces kinetosis-induced disturbances can be simplified.

For determining some of the stimuli acting on the occupant, in a further embodiment of the method, signals are detected by means of an on-board acceleration sensor system for determining a movement of the vehicle body, the transverse dynamics, a rolling motion and/or a pitching motion of the vehicle. It is thus possible to counteract it, by means of at least one suitable countermeasure, for example such as a corresponding chassis adjustment.

A development of the method provides that for determining the stimuli acting on the occupant, vehicle movements for a route ahead of the vehicle are determined on the basis of data from a digital map and/or on the basis of data from the vehicle's navigation system. In this way, movements of the vehicle that lead to kinetosis-induced disturbances can be predicted, so that corresponding countermeasures can be taken in advance, so as to be able to reduce the risk of development of kinetosis-induced disturbances considerably.

In order to determine an occupant's susceptibility to kinetosis-induced disturbances, in a further possible embodiment of the method the occupant's individual susceptibility is determined on the basis of completion of a questionnaire. For this purpose, in particular the occupant completes a standardized questionnaire, wherein the questionnaire is only completed once and a value determined for susceptibility is then stored in the profile of the corresponding occupant. If the occupant's susceptibility changes, the value of the occupant's intraindividual susceptibility is adapted. This adaptation constitutes an iterative process.

In a possible development of the method, to reduce the stimuli acting on the occupant, the occupant is recommended to take an alternative route, depending on the vehicle movements predicted for a route ahead of the vehicle. In particular, driving an alternative route is recommended if all other available countermeasures cannot counteract the occurrence of kinetosis-induced disturbances and the occupant would among other things suffer nausea and/or headaches.

In order to reduce the kinetosis-induced disturbances, in a further embodiment of the method it is provided that the vehicle's driving dynamics are adapted, route planning is carried out as a function of a driving profile and/or traffic volume, the occupant is stabilized on the basis of seat adjustments, lighting in the vehicle is controlled, settings of a display unit are adapted and/or comfort adjustments, such as fragrance, temperature, massage etc., are carried out.

Furthermore, in one embodiment the method provides that for validation of the effects of individual measures introduced, there is feedback of setting parameters of individual measures taken to a central computer unit connected to the vehicle, so that the package of measures relating to reduction of kinetosis-induced disturbances can be improved. Thus, for example, a seat adjustment, relative to another proposed seat adjustment, may result in dizziness stopping completely, whereas the occupant became dizzy despite the proposed seat adjustments. For this reason, feedback takes place, so that this seat adjustment can be included additionally or alternatively in the package of measures and therefore can be made available to occupants of other vehicles.

Embodiment examples of the invention are explained in more detail hereunder, with a drawing.

### BRIEF DESCRIPTION OF THE DRAWING

The FIGURE, schematically, is a perspective view of a detail of a vehicle with an occupant.

### DETAILED DESCRIPTION OF THE DRAWING

The FIGURE shows a detail of a vehicle 1 with an occupant 2 on a vehicle seat 3.

The occupant 2 is a vehicle user, i.e., a driver of the vehicle 1, who performs a driving task in the manual driving mode of the vehicle 1.

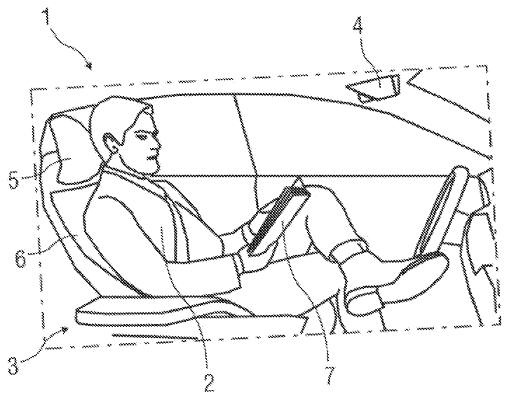

The vehicle 1 has an assistance system for autonomous driving, so that the occupant 2 can pursue other activities during autonomous driving. According to the present embodiment example, in FIG. 1 the occupant 2 is reading, while the vehicle 1 drives autonomously to the destination he has specified.

As the occupant 2, who may also be a front-seat passenger or some other occupant 2, is distracted from the driving process and is concentrating on the other activity, in particular reading, there is a risk of development of kinetosis-induced disturbances, kinetosis being designated as travel or motion sickness.

Kinetosis may also occur for a front-seat passenger or some other occupant 2 in the back of the vehicle 1, if the vehicle 1 does not have the assistance system for autonomous driving.

Kinetosis includes physical reactions such as pallor, headaches, nausea, vomiting and dizziness, which an occupant 2 develops as a result of unusual motion, in particular in a vehicle 1. The physical reactions are called kinetosis-induced disturbances or symptoms.

In order to make the driving of the vehicle 1 as pleasant as possible for the occupant 2, as far as this is possible, a method described hereunder is provided for predicting and reducing kinetosis-induced disturbances.

In the vehicle 1, i.e., in its passenger compartment, a vehicle camera 4 is arranged, which acquires image data continually during driving, wherein the vehicle camera 4 is configured and oriented in such a way that occupants 2 present in the vehicle 1 are within the acquisition range of the vehicle camera 4. As an alternative, the number of vehicle cameras 4 installed in the vehicle 1 may vary, so that at least two vehicle cameras 4 are present.

The method comprises an algorithm for predicting kinetosis-induced disturbances, wherein various input variables are required for determining a characteristic figure. For example, the algorithm is based on a clustering method in conjunction with a learning system and/or on regression models.

The algorithm consists of two mutually independent or collaborative expansion stages.

Expansion stage 1 of the algorithm is defined in terms of a statistical/stochastic model, which was created and validated via a Linear Mixed Model in the real driving environment. Potential variables are integrated into a regression model gradually (“forward selection”). The potential improvement of model fitting and therefore also the relevance of the variable for the expression of kinetosis are revealed on the basis of statistical quality criteria. The corresponding forms of the identified variables are now classified with respect to their kinetosis provocation, i.e., the extent to which they cause or intensify the occurrence of kinetosis, and are integrated in the statistical model. Corresponding sensors detect or predict the status of the variable continuously or at regular intervals. If there is a change in expression of the variable, through manual adaptation or through an automated initiation, the status of the prediction model is also adapted. The prediction model can be expanded or reduced continuously with further variables, their states of expression, interaction effects, etc.

Expansion stage 2 is a learning statistical model (Machine Learning), which in the course of use is improved or tailored to the occupant on the basis of collected data including individual preferences. The corresponding adaptation takes place by means of a training data set and on the basis of the model of positive and negative feedback.

Stimuli that act on the occupant 2 during driving form one input variable of the algorithm, and the individual susceptibility of the occupant 2 and the type of activity undertaken by the occupant 2 while driving, a so-called secondary activity, form further input variables.

Driving-dynamics characteristics, for example such as seat adjustment, driving profile and/or travel time, are detected or determined as stimuli that act on the occupant 2 during driving, in particular during autonomous driving.

The individual susceptibility of the occupant 2 is for example determined by means of at least one questionnaire, which can be answered for example by means of a mobile data processing unit connected to a central computer unit, in particular a smartphone, and/or by means of an infotainment system of the vehicle 1.

The type of activity carried out by the occupant 2, for example reading, playing, looking out of the window and/or whether the occupant 2 is conversing, can be determined from image data captured by the vehicle camera 4.

Based on the input variables, a characteristic figure is determined, which indicates or makes a prediction of the probability of kinetosis-induced disturbances occurring for the occupant 2.

In order to counteract kinetosis-induced disturbances, in particular not to allow them to develop in the first place, a package of measures is stored in the vehicle 1 for prevention on the basis of this characteristic figure, with a plurality of individual measures, i.e., countermeasures.

Examples of individual measures are driving-dynamics measures, a change in route planning, changes to the seat adjustment and comfort settings, wherein feedback of the countermeasures with respect to the algorithm is provided.

With respect to the stimulus acting on the occupant 2 or the stimuli acting on the occupant 2, a type and duration of the stimulus or stimuli is/are determined.

For this purpose it is provided that an activity of the occupant 2, i.e., the activity carried out, and the duration thereof are determined from the image data captured by the vehicle camera 4. If present, the type of activity is summarized, i.e., clustered, for example according to the degree of distraction and attention/demands on attention, according to the presence of visual dynamics, with respect to the need for constant attention, e.g., with a small diversion of gaze, and/or as a function of a sitting position of the occupant 2 in the vehicle 1. In particular, the activities are assigned to an activity category, wherein activities of one activity category are the same with respect to a number of the aforementioned properties.

With respect to the vestibular apparatus and proprioception, detected signals of an on-board acceleration sensor system are evaluated for example with respect to movement of the vehicle body, transverse dynamics, a rolling and/or a pitching motion.

In particular, the detected signals of the acceleration sensor system are analysed with respect to physical movement stimuli to which the occupant 2 is subjected. Besides analyses in the time range, for example a mean value calculation, and/or by using sliding effective values with assessment functions, additional analyses are possible in the frequency range. For example, an energy and/or performance density may be analysed. In particular, a frequency in the range from 0.2 Hz turns out to be critical with respect to the occurrence of kinetosis-induced disturbances.

In addition, the image data of the vehicle camera 4 may be evaluated with respect to head movements of the occupant 2. If it is determined that a relative movement between the head of the occupant 2 and a headrest 5 is comparatively large, there is a risk of kinetosis.

Map data and data from the navigation system of the vehicle 1 are used for obtaining data on the driving profile, a set driving time and development of traffic congestion, for example on a stretch of road ahead of the vehicle 1. By means of these data it is possible not only to examine a period in the past, but a forecast can also take place, in order to be able to predict future vehicle movements.

An intra- and interindividual susceptibility of the occupant 2 relative to the occurrence of kinetosis-induced disturbances is determined, as described above, by answering at least one standardized questionnaire. A value determined on the basis of the susceptibility is only input once in the vehicle 1 and is stored in the profile of the occupant 2. If, through the use of a learning system, a learning effect or adaptation of the occupant 2 to certain events is recognized, this value of the intra- and interindividual susceptibility of the occupant 2 is adapted. Thus, determination of the value of the intraindividual susceptibility of the occupant 2 takes place as an iterative process.

Furthermore, for predicting the development of kinetosis-induced disturbances, the instantaneous wellbeing and comfort criteria are taken into account. The instantaneous wellbeing or typical kinetosis indicators, such as yawning, sweating and/or a comparatively nervous sliding to and fro of the occupant 2, is or are determined by means of the recorded image data of the vehicle camera 4 and/or with signals detected by other suitable sensors in the vehicle 1. Besides detection of head position, acceleration and/or movement, it is also possible to achieve detection of the stress level with the camera, by detecting the blood circulation of the head (temperature measurement).

In particular, measurement of brain waves, the so-called EEG, serves for predicting kinetosis-induced disturbances, since triggering signals for excitation of vestibular nuclei and of the reticular formation can be recognized from the brain waves. Such data are supplemented with behaviour-based measurements and classical physical data.

Together with comfort criteria, such as air conditioning of the vehicle 1, these data are integrated in the algorithm.

A type and intensity of expression of the individual input variables of the algorithm is transferred by means of the learning system to a stochastic prediction model.

With increasing number of users of the method described it will be possible to form clusters, which make a relatively accurate prediction of the potential intensity of kinetosis possible.

The statistical prediction model comprises, besides aspects of a learning system, existing findings, e.g., of a dependence of amplitude and frequency with respect to the intensity of kinetosis.

As described above, use is made of the individual measures of the package of measures for preventing the development of kinetosis-induced disturbances. Moreover, the package of measures comprises various setting parameters and influencing variables with corresponding intensity features.

Activation of an individual measure, which can take place manually or automatically, takes place by means of a suggestion, which is based on an exceeded threshold value of the characteristic figure in the prediction model.

The driving dynamics of the vehicle 1 have effects on longitudinal, transverse and vertical dynamics, wherein to reduce the driving dynamics, among other things, a pitch and roll stabilization may take place, rear axle steering may be adjusted and/or a chassis characteristic may be adapted in order to influence the vertical dynamics.

With respect to route planning, the occupant 2 may be proposed taking an alternative route, which induces no or at least fewer kinetosis-induced disturbances. To avoid the development of kinetosis-induced disturbances, the driving profile has fewer bends, avoids town traffic and hairpin bends. Moreover, a selected driving route or the alternative route should have a low traffic volume and therefore no congestion, so that the travel time can be reduced.

Furthermore, it is provided that a system for route planning will be adapted, wherein for longitudinal dynamics, limit and threshold values will be preset for braking and acceleration operations and intervention takes place early, so that smooth acceleration and deceleration of the vehicle 1 is possible. With respect to the transverse dynamics, a steering angle is adapted when cornering.

As a further countermeasure for reducing the development of kinetosis-induced disturbances, a change in seat adjustment may be carried out on the vehicle seat 3. For example, the head of the occupant 2 can be supported by moving the headrest 5 forward.

The vehicle seat 3 and/or its seat back 6 may be moved to a position that is favourable for the occupant 2, for example a reclining position, wherein additionally or alternatively driving-dynamic seat bladders and/or a seat belt pretensioning device may be activated for stabilizing the occupant 2 in his or her position.

A lighting setting in the vehicle 1 may be carried out for preventing the development of kinetosis-induced disturbances, wherein dynamics are imparted by means of moving lights, in particular a moving strip, in the vehicle 1. If the occupant 2 is reading, as shown in the embodiment example, suitable illumination is provided for a region in which a book 7 is located.

Furthermore, an artificial horizon and/or cross hairs may be shown on a display unit in the vehicle 1, in particular a display unit of an infotainment system, wherein the dynamics of the indicated contents is adapted corresponding to the driving dynamics.

With respect to the comfort settings, it is determined, on the basis of map data and data from the navigation system, which section of the route is the most suitable for the particular activity. If it is known which activity the occupant 2 intends to carry out during autonomous driving of the vehicle 1, the occupant 2 is recommended a suitable section of the route for carrying out the activity, depending on the travel time and the route.

Settings of the air conditioning of the vehicle 1 may be altered so that an air flow is cooled and is directed onto the head of the occupant 2, wherein scenting may be activated and for example the odour of peppermint or ginger may pervade the vehicle 1, to prevent kinetosis-induced disturbances.

Moreover, it may be provided that the respiration of the occupant 2 is affected by acoustic settings and/or a massage rhythm of a massage system of the vehicle seat 3, in order at least to reduce the risk of development of kinetosis-induced disturbances.

Weighting of the individual measures takes place by means of the learning system and is also supplemented with individual preferences. Moreover, the package of measures at first comprises known individual measures, i.e., known countermeasures, which have been investigated and validated by means of studies carried out on test subjects.

Furthermore, individual measures that have been selected and implemented for an occupant 2 on the basis of the characteristic figure, are included in the algorithm again as further input variables. In this way it is possible to assess to what extent the special measure has brought about an improvement. These findings are improved for the further improvement of the algorithm. Measures are therefore also taken into account in the prediction model, so that the characteristic value is constantly calculated and updated.

From the existing individual profile of the occupant 2 and/or by means of the learning system, which recognizes for feedback which countermeasure the respective occupant 2 and/or other persons inside and outside of the cluster have selected, the method is improved iteratively. For this, the learning system is connected to a central computer unit, wherein the learning system may be a component part of the central computer unit.

The respective countermeasure is recommended to the occupant 2 or activated automatically. Automatic input takes place when detailed data, little data or no data are available concerning the countermeasure, whereas a countermeasure is recommended for manual activation if detailed data are available concerning the countermeasure or it is necessary to activate a program.

1.-8. (canceled)

9. A method for predicting and reducing kinetosis-induced disturbances of an occupant in driving of a vehicle, comprising the steps of:
detecting the occupant by a vehicle camera;
determining a characteristic figure that indicates a probability of onset of kinetosis-induced disturbances as a function of stimuli acting on the occupant, an individual susceptibility of the occupant with respect to kinetosis, and a type of activity carried on while driving; and
as a function of the determined characteristic figure determined, recommending at least one individual measure of a package of measures for preventing kinetosis-induced disturbances to the occupant or initiating automatically the at least one individual measure.

10. The method according to claim 9, wherein the type of activity is assigned to an activity category as a function of:
a degree of distraction or attention of the occupant; or
a demand on the occupant's attention; or
a required visual dynamics of the occupant; or
a required constant attention of a gaze of the occupant or a slight turning away of the gaze of the occupant; or
a sitting position of the occupant in the vehicle.

11. The method according to claim 9, wherein, for determining the stimuli acting on the occupant, signals are detected by an on-board acceleration sensor system for determining a movement of vehicle.

12. The method according to claim 9, wherein, for determining the stimuli acting on the occupant, vehicle movements are determined for a route ahead of the vehicle on a basis of data from a digital map or on data from a navigation system of the vehicle

13. The method according to claim 9, wherein the individual susceptibility of the occupant is determined on a basis of completion of a questionnaire.

14. The method according to claim 9, wherein, to reduce the stimuli acting on the occupant, driving of an alternative route is recommended to the occupant as a function of predicted vehicle movements for a route ahead of the vehicle.

15. The method according to claim 9, wherein, to reduce the stimuli acting on the occupant:
driving dynamics of the vehicle is adapted; or
route planning is carried out as a function of a driving profile or a traffic volume; or
the occupant is stabilized on a basis of seat adjustments; or
lighting in the vehicle is controlled; or
settings of a display unit are adapted; or
comfort settings are undertaken.

16. The method according to claim 9, wherein, for validation of an effect of the at least one individual measure, feedback of setting parameters of the at least one individual measure is stored in a central computer unit connected to the vehicle.
